(19) United States
(12) Patent Application Publication
(10) Pub. No.: US 2008/0110733 A1
(43) Pub. Date: May 15, 2008

(54) Tilt responsive circuit controller utilizing conductive particles

(75) Inventor: Anthony M. Wu, Vista, CA (US)

Correspondence Address: DIRECTED ELECTRONICS, INC., 1 VIPER WAY, VISTA, CA, 92061, US

(73) Assignee: DEI Headquarters Inc.

(21) Appl. No.: 11/600,369

(22) Filed: Nov. 15, 2006

(51) Int. Cl. H01H 35/02

(52) U.S. Cl. 200/61.52

(57) ABSTRACT

A tilt-responsive circuit controller includes a casing defining a vacuum-sealed interior region, the casing having a first end, a second end, and a tubular portion disposed there between. A first set of conductive contacts are coupled to the first end and partially disposed within the interior region. A plurality of conductive particles is contained within the interior region, the particles each being substantially spherical and having a diameter substantially less than casing diameter. The particle diameter can also be less than the distance between the conductive contacts. The casing includes a friction-reducing substance coated on the inner surface. A second set of contacts can be coupled to the second end and a third set of contacts can be coupled to the tubular portion. The contacts can be connected solely to the tubular member, or one can be connected to the tubular member and one to an end.

### FIELD OF THE INVENTION

The embodiments of the present invention relate generally to electrical switches, and, more particularly, to tilt-responsive electrical switches that utilize non-liquid conductive elements.

### BACKGROUND

There exist many types of electrical switches that can function in various environments and serve various purposes. In general, electrical switches consist of a pair of electrical contacts and moveable means for making and breaking electrical continuity between the electrical contacts. One particular type of switch, an electrical tilt switch, operates to open or close electrical circuits depending on the incline angle of the switch. A tilt switch generally comprises a conductive substance, typically liquid mercury, enclosed in a glass casing with electrical contacts connected thereto. When the switch is tilted in one direction, the conductive substance rolls to one end of the casing and closes a circuit between two contacts, and when the switch is tilted to the other direction, the conductive substance rolls away from the contacts and the electrical circuit is opened. Typical uses of tilt switches are in thermostats, wherein the switch is configured to detect an inclination angle change of as little as one degree, in the control industry, and also in many automotive applications such as remote start systems and security systems.

Although mercury tilt switches are generally simple and inexpensive to manufacture, the toxic effect of mercury on the environment has led to a movement to eliminate the use of mercury in many electrical products, including electrical tilt switches. Some inventions have sought to use a different conductive substance in tilt switches other than mercury. For example, a common substitute for mercury in a tilt switch is free moving conductive element, such as a single metal ball. Tilt switches utilizing metal balls in place of mercury are generally known, examples of which are described in U.S. Pat. No. 4,628,160 to Canevari and U.S. Pat. No. 3,763,484 to Byers. The use of a metal ball to complete an electric circuit is a simple and inexpensive way to create a tilt switch. However, the use of a metal ball has a major drawback in that the metal ball is easily subject to movement away from the contacts and breaking of the circuit due to vibrations of the switch. Additionally, tilt switches that employ spherical conductors generally require that the spherical conductor roll along a predefined path from a conductive position to a non-conductive position, and vice-versa. However, when electrical current is made or broken by the spherical conductor moving into or out of contact with a stationary conductor, it is common for arcing to occur, which can create pitting on the surface of the sphere. The pitting of the sphere's surface can then interfere with the smooth rolling of the conductive sphere during later cycles of its operation, and thus, the effectiveness and reliability of the switch. A further disadvantage to the use of a single metal conductor is the limited amount of surface area that engages the contacts, which decreases the current conducting capacity of the tilt switch.

Therefore, it would be advantageous to provide a tilt-responsive circuit controller that can is not susceptible to breaking of the electrical connection when subjected to minor vibrations, that is not prone to the effects of arcing, that has increased current carrying capacity, and that is simple, reliable, and cost-efficient to manufacture.

### SUMMARY

The preferred embodiment of the invention provides a tilt-responsive circuit controller having a casing defining a vacuum-sealed interior region, the casing having a first end, a second end, and a tubular portion connected to and disposed between the first end and the second end, a first set of conductive contacts coupled to the first end of the casing, and a plurality of conductive particles contained within the interior region. The plurality of conductive particles each have a diameter substantially less than the diameter of the casing, can be spherical in shape, and can be comprised of several conductive materials such as gold, nickel, copper, steel and tin. The casing includes a friction-reducing substance, such as a fluoropolymer, coated on the inner surface thereof. The casing can comprise glass, a ceramic material, a conductive material, a polymeric material, or combinations and variations thereof. When the circuit controller is placed within an electrical circuit and when the casing is disposed at a first angled position, the plurality of conductive particles accumulate towards the first end of the casing and contact the first set of conductive contacts, causing the closing of the electrical circuit. When the casing is disposed at a second angled position the plurality of conductive particles accumulate towards the second end of the casing, causing the opening of the electrical circuit.

Another embodiment of the invention provides a tilt-responsive circuit controller having a casing defining a vacuum-sealed interior region, the casing having a first end, a second end, and a tubular portion connected to and disposed between the first end and the second end, a first set of conductive contacts coupled to the first end of the casing, a second set of conductive contacts coupled to the second end of the casing, and a plurality of conductive particles contained within the interior region. The plurality of conductive particles each contain a diameter substantially less than the diameter of the casing, can be spherical in shape, and can be comprised of several conductive materials such as gold, nickel, copper, steel and tin. The casing includes a friction-reducing substance, such as a fluoropolymer, coated on the inner surface thereof. The casing can comprise glass, a ceramic material, a conductive material, a polymeric material, or combinations and variations thereof. When the circuit controller is placed within an electrical circuit and when the casing is disposed at a first angled position, the plurality of conductive particles accumulate towards the first end of the casing and contact the first set of conductive contacts, causing the closing of the electrical circuit. When the casing is disposed at a second angled position the plurality of conductive particles accumulate towards the second end of the casing, causing the opening of the electrical circuit at the first end and the closing of an electrical circuit at the second end.

A further embodiment of the invention provides a tilt-responsive circuit controller having a casing defining a vacuum-sealed interior region, the casing having a first end, a second end, and a tubular portion connected to and disposed between the first end and the second end, a first set of conductive contacts coupled to the first end of the casing, a second set of conductive contacts coupled to the second end of the casing, a third set of conductive contacts coupled to the tubular portion of the casing, and a plurality of conductive particles contained within the interior region. The plurality of conductive particles each contain a diameter substantially less than the diameter of the casing, can be spherical in shape, and can be comprised of several conductive materials such as gold, nickel, copper, steel and tin. The casing includes a friction-reducing substance, such as a fluoropolymer, coated on the inner surface thereof. The casing can comprise glass, a ceramic material, a conductive material, a polymeric material, or combinations and variations thereof. When the circuit controller is placed within an electrical circuit and when the casing is disposed at a first angled position, the plurality of conductive particles accumulate towards the first end of the casing and contact the first set of conductive contacts, causing the closing of the electrical circuit. When the casing is disposed at a second angled position the plurality of conductive particles accumulate towards the second end of the casing, causing the opening of the electrical circuit at the first end and the closing of an electrical circuit at the second end. When the casing is disposed at a third position, the plurality of conductive particles accumulate within the tubular portion of the casing and contact the third set of conductive contacts, causing the opening of the electrical circuit at the first end and the second end and causing the closing of an electrical circuit connected to the third set of conductive contacts.

Still another embodiment of the invention provides a tilt-responsive circuit controller having a casing defining a vacuum-sealed interior region, the casing having a first end, a second end, and a tubular portion connected to and disposed between the first end and the second end, a first set of conductive contacts coupled to the region of the tubular portion substantially adjacent to the first end, and a plurality of conductive particles contained within the interior region. The plurality of conductive particles each have a diameter substantially less than the diameter of the casing, can be spherical in shape, and can be comprised of several conductive materials such as gold, nickel, copper, steel and tin. The casing includes a friction-reducing substance, such as a fluoropolymer, coated on the inner surface thereof. The casing can comprise glass, a ceramic material, a conductive material, a polymeric material, or combinations and variations thereof. When the circuit controller is placed within an electrical circuit and when the casing is disposed at a first angled position, the plurality of conductive particles accumulate towards the first end of the casing and contact the first set of conductive contacts, causing the closing of the electrical circuit. When the casing is disposed at a second angled position the plurality of conductive particles accumulate towards the second end of the casing, causing the opening of the electrical circuit.

Still yet another embodiment of the invention provides a tilt-responsive circuit controller having a casing defining a vacuum-sealed interior region, the casing having a first end, a second end, and a tubular portion connected to and disposed between the first end and the second end, a first conductive contact coupled to the first end of the casing, a second conductive contact coupled to the region of the tubular portion substantially adjacent to the first end, and a plurality of conductive particles contained within the interior region. The plurality of conductive particles each have a diameter substantially less than the diameter of the casing, can be spherical in shape, and can be comprised of several conductive materials such as gold, nickel, copper, steel and tin. The casing includes a friction-reducing substance, such as a fluoropolymer, coated on the inner surface thereof. The casing can comprise glass, a ceramic material, a conductive material, a polymeric material, or combinations and variations thereof. When the circuit controller is placed within an electrical circuit and when the casing is disposed at a first angled position, the plurality of conductive particles accumulate towards the first end of the casing and contact the first conductive contact and the second conductive contact, causing the closing of the electrical circuit. When the casing is disposed at a second angled position the plurality of conductive particles accumulate towards the second end of the casing, causing the opening of the electrical circuit.

These and other features and aspects of the embodiments of the invention will be better understood with reference to the following description, drawings, and appended claims.

### BRIEF DESCIRPTION OF THE FIGURES

FIG. 1 shows a partially broken away perspective view of the preferred embodiment of the tilt responsive circuit controller utilizing conductive particles.

FIG. 2A shows a cross-section view of the preferred embodiment of the tilt responsive circuit controller utilizing conductive particles in a first angled position, wherein the conductive particles engage the conductive contacts to create a closed electrical circuit.

FIG. 2B shows a cross-section view of the preferred embodiment of the tilt responsive circuit controller utilizing conductive particles in a second angled position, wherein the conductive particles are positioned away from the conductive contacts to create an opened electrical circuit.

FIG. 3A shows a cross-section view of another embodiment of the tilt responsive circuit controller utilizing conductive particles in a first angled position, wherein the conductive particles engage the first set of conductive contacts to create a closed electrical circuit.

FIG. 3B shows a cross-section view of another embodiment of the tilt responsive circuit controller utilizing conductive particles in a second angled position, wherein the conductive particles engage the second set of conductive contacts to create a closed electrical circuit on one end and an open electrical circuit on the other end.

FIG. 4A shows a cross-section view of a further embodiment of the tilt responsive circuit controller utilizing conductive particles in a first angled position, wherein the conductive particles engage the conductive contacts to create a closed electrical circuit.

FIG. 4B shows a cross-section view of a further embodiment of the tilt responsive circuit controller utilizing conductive particles in a second angled position, wherein the conductive particles are positioned away from the conductive contacts to create an opened electrical circuit.

FIG. 5A shows a cross-section view of still another embodiment of the tilt responsive circuit controller utilizing conductive particles in a first angled position, wherein the conductive particles engage the conductive contacts to create a closed electrical circuit.

FIG. 5B shows a cross-section view of still another embodiment of the tilt responsive circuit controller utilizing conductive particles in a second angled position, wherein the conductive particles are positioned away from the conductive contacts to create an opened electrical circuit.

FIG. 5C shows a cross-section view of still another embodiment of the tilt responsive circuit controller utilizing conductive particles in a third angled position, wherein the conductive particles are positioned away from the conductive contacts to create an opened electrical circuit.

FIG. 6A shows a cross-section view of still yet another embodiment of the tilt responsive circuit controller utilizing conductive particles in a first angled position, wherein the conductive particles engage the first set of conductive contacts to create a closed first electrical circuit.

FIG. 6B shows a cross-section view of still yet another embodiment of the tilt responsive circuit controller utilizing conductive particles in a second angled position, wherein the conductive particles engage the second set of conductive contacts to create a closed second electrical circuit.

FIG. 6C shows a cross-section view of still yet another embodiment of the tilt responsive circuit controller utilizing conductive particles in a third angled position, wherein the conductive particles engage the third set of conductive contacts to create a closed third electrical circuit.

FIG. 7A shows a cross-section view of a prior art tilt-responsive circuit controller utilizing a single conductive ball, with the controller in an undisturbed state.

FIG. 7B shows a cross-section view of a prior art tilt-responsive circuit controller utilizing a single conductive ball, with the controller in a disturbed state.

FIG. 8A shows a cross-section view of the preferred embodiment of the tilt responsive circuit controller utilizing conductive particles, with the controller in an undisturbed state.

FIG. 8B shows a cross-section view of the preferred embodiment of the tilt responsive circuit controller utilizing conductive particles, with the controller in a disturbed state.

### DETAILED DESCRIPTION OF THE EMBODIMENTS

Reference will now be made in detail to several embodiments of the invention that are illustrated in the accompanying drawings. Wherever possible, same or similar reference numerals are used in the drawings and the description to refer to the same or like parts. The drawings are in a simplified form and are not to precise scale. For purposes of convenience and clarity only, directional terms, such as, top, bottom, left, right, up, down, over, above, below, beneath, rear, and front, may be used with respect to the accompanying drawings. These and similar directional terms should not be construed to limit the scope of the invention in any manner. Furthermore, in descriptions and in claims, “couple,” “connect,” and similar words with their inflectional morphemes do not necessarily import an immediate or direct connection, but include connections through mediate elements within their meanings.

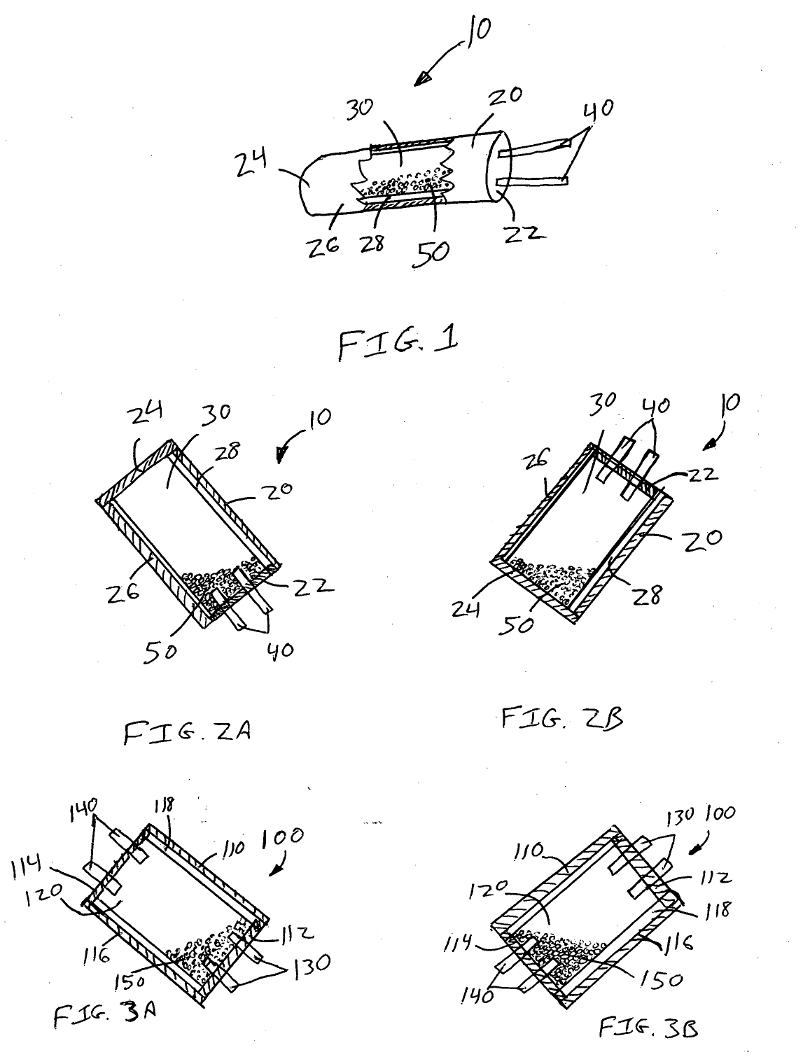

Referring more particularly to the drawings, FIG. 1 shows a partially broken away perspective view of the preferred embodiment of the tilt responsive circuit controller utilizing conductive particles 10. Controller 10 includes a casing 20, a set of conductive contacts 40, and a plurality of conductive particles 50 contained within casing 20. Casing 20 defines a vacuum-sealed interior region 30, and includes a first end 22, a second end 24, and a tubular portion 26 connected to and disposed between first end 22 and second end 24. In certain embodiments, first end 22 or second end 24 can be manufactured as a part of tubular portion 26, with the other end portion being coupled to tubular portion 26. In other embodiments, tubular portion 26 can comprise a separate portion apart from first end 22 or second end 24. The diameter and wall thickness of tubular portion 26 can vary depending on the particular application for controller 10. Casing 20 includes a friction-reducing substance 28 coated on the inner surface thereof. Substance 28 can be a flouropolymer, or other substance that reduces friction between materials. Casing 20 can comprise glass, a ceramic material, a conductive material, a polymeric material, or combinations and variations thereof. Casing 20 can be manufactured by various methods, or combinations of methods, as recognized in the art, including molding, machining, sheet metal stamping, extrusion, and casting.

Conductive contacts 40 are coupled to first end 22. First end 22 is preferably comprised of a non-conductive material, with conductive contacts 40 extending through first end 22 such that conductive contact 40 is exposed to interior region 30. Contacts 40 are coupled to first end 22 such that they are separated by a contact separation distance. The contact separation distance can vary depending on the size of casing 20. Contacts 40 can be comprised of various conductive materials such as gold, nickel, copper, steel, lead and tin.

Conductive particles 50 each have a diameter substantially less than the diameter of casing 20. Conductive particles 50 are preferably spherical in shape, however, they can also be various other shapes that are capable of moving along a surface. Conductive particles 50 can be comprised of several conductive materials such as gold, nickel, copper, steel, lead, and tin. When controller 10 is placed within an electrical circuit and when casing 20 is disposed at a first angled position (see FIG. 2A), conductive particles 50 accumulate towards first end 22 and contact conductive contacts 40, causing the closing of the electrical circuit. When casing 20 is disposed at a second angled position (see FIG. 2B), conductive particles 50 accumulate towards second end 24, causing the opening of the electrical circuit. It should be noted that the size and number of conductive particles 50 within casing 20 can vary based upon factors such as the size of particles 50, the size of casing 20, the size and location of contacts 40, and the desired functionality and reliability of the controller 10. For example, more conductive particles 50 can be used to ensure that controller 10 can function under in environments containing a high level of vibrational activity, while less conductive particles 50 can be used if controller 10 will be used in an environment containing a low level of vibrational activity.

The use of a plurality of conductive particles 50 within a tilt-responsive switch provides several advantages. First, the use of a plurality of conductive particles 50 within casing 20 prolongs the ability of the switch to bear the effects of arcing. Having many conductive particles that can make electrical contact allows for the effects of arcing to be distributed over a larger number of objects, which cumulatively contain a larger surface area that must be exposed to arcing in order to reduce the functionality of the switch. For example, in switches containing a single metallic ball, once a certain amount of the surface of the ball is pitted, the ball will not sufficiently roll along the surface of the switch to make or break electrical connection with the various contacts. However, if the switch utilizes a plurality of metallic balls, sized such that the balls have a diameter substantially smaller than the diameter of the casing to allow the balls to move around and switch positions within the casing, the amount of pitting that must occur before all of the balls do not sufficiently roll along the surface of the switch to make or break electrical connection with the various contacts is significantly increased, as electrical connection with contacts 40 can be made with a different ball each time, thus increasing the life of the switch.

A second advantage for using a plurality of particles 50 having a diameter substantially smaller than the diameter of casing 20 is the increased ability of device 10 to withstand the effects of vibration without causing a loss of electrical conduction. For example, in prior art switches employing a single metallic ball, the ball generally rests upon two conductive contacts connected to an electrical circuit. Because the ball rests upon the contacts, the ball and contacts form two contact points for current to flow through. When external forces or vibrations act upon the switch, a slight movement of the ball off of the contact points will cause the conduction path to be broken. With device 10 however, along with the other embodiments contained within this invention, particles 50 can surround contacts 40 to engage more surface area of contacts 40 (see for example, FIG. 2A). If device 10 is subjected to a slight or moderate external force or vibration, causing particles 50 to move upward away from end 22, several particles 50 will still be contacting contacts 40 to provide an electrical conduction path (compare FIGS. 7A and 7B with FIGS. 8A and 8B for illustration).

A further advantage for using a plurality of particles 50 having a diameter substantially smaller than the diameter of casing 20 is the increased amount of current handling capacity of device 10. Because particles 50 can surround contacts 40 to engage more surface area of contacts 40, the conduction path between contacts 40 is larger than that found in prior art switches such as those utilizing single ball conductors. A larger conduction path allows device 10 to withstand a higher current, which provides more flexibility in the applications that can utilize such a device. For example, an increased current capacity allows device 10 to be used in high-power applications that previous tilt-responsive circuit controllers were not suitable for.

Controller 10, as well as the other embodiments of the invention as described herein, can be used in several applications, including automotive based applications such as remote start and security systems. For example, the controllers can be used in a remote engine start system to detect the opening of the vehicle's hood during a remote start procedure. If this scenario, the controller is secured to the interior of the hood of the vehicle such that, when the hood is closed, the plurality of particles are not engaged with the conductive contacts. When the hood is opened, the conductive particles contact the conductive contacts and cause the electrical circuit to close, causing a signal to be sent to an alarm controller or other controller to prevent the starting of the vehicle. The various controllers can also be used in a security system to detect the opening of the trunk so that an alarm can be triggered, to detect a parked car being jacked up to notify a user of unauthorized towing or the unauthorized removal of the vehicles wheels, to detect a parked motorcycle being moved from the parked position for unauthorized removal, to detect the movement of a protected movable object, such as a convertible top of a vehicle, from a rest position to a new position, or to detect the opening of a door or trunk in a remote control security system or a comfort-convenience system to provide a contact to activate an illumination means.

Controller 10, as well as the other embodiments of the invention as described herein, can also be used in non-vehicle related environments. For example, the various controllers can be used in various sensors including motion sensors, acceleration sensors, and orientation sensors. Also, the various controllers can be used within numerous portable electronics devices such as personal digital assistants, cell phones, handheld radios and other portable music devices, calculators and radio frequency transmitters. Other applications include in mechanical toys, robotic devices, lighting devices, thermostats, avionic devices, signaling devices, and other devices as would be recognized by one with ordinary skill in the art.

FIG. 2A shows a cross-section view of controller 10 in a first angled position. In this position, conductive particles 50 accumulate towards first end 22 and contact conductive contacts 40. If contacts 40 are connected to an electrical circuit (not shown), the circuit will be closed and electricity will flow through conductive particles 50.

FIG. 2B shows a cross-section view of controller 10 in a second angled position. In this position, conductive particles 50 accumulate towards second end 24, away from conductive contacts 40. If contacts 40 are connected to an electrical circuit (not shown), the circuit will be broken and electricity will not flow through the circuit.

FIG. 3A shows a cross-section view of another embodiment of the tilt responsive circuit controller utilizing conductive particles 100 in a first angled position. Controller 100 includes a casing 110, a set of conductive contacts 130, and a plurality of conductive particles 150 contained within casing 110. Casing 110 defines a vacuum-sealed interior region 120, and includes a first end 112, a second end 114, and a tubular portion 116 connected to and disposed between first end 112 and second end 114. Casing 110 includes a friction-reducing substance 118 coated on the inner surface thereof. Substance 118 can be a flouropolymer, or other substance that reduces friction between materials. Casing 110 can be comprised of a ceramic material, a conductive material, or a polymer material.

Conductive contacts 130 are coupled to first end 112. Contacts 130 are separated by a distance that can vary depending on the size of casing 110. Conductive contacts 140 are coupled to second end 114. Contacts 140 are separated by a distance that can vary depending on the size of casing 110. Conductive particles 150 each have a diameter substantially less than the diameter of casing 110. Conductive particles 150 are preferably spherical in shape, however, they can also be various other shapes that are capable of moving along a surface. Conductive particles 150 can be comprised of several conductive materials such as gold, nickel, copper, steel and tin.

In the position as shown, conductive particles 150 accumulate towards first end 112 and contact conductive contacts 130. If contacts 130 are connected to an electrical circuit (not shown), the circuit will be closed and electricity will flow through conductive particles 150.

FIG. 3B shows a cross-section view of controller 100 in a second angled position. In this position, conductive particles 150 accumulate towards second end 114 and contact conductive contacts 140, and away from conductive contacts 130. If contacts 140 are connected to an electrical circuit (not shown), the circuit connection will be closed and electricity will flow through conductive particles 150. If contacts 130 are connected to an electrical circuit (not shown), the circuit connection will be broken and electricity will not flow through that electrical circuit.

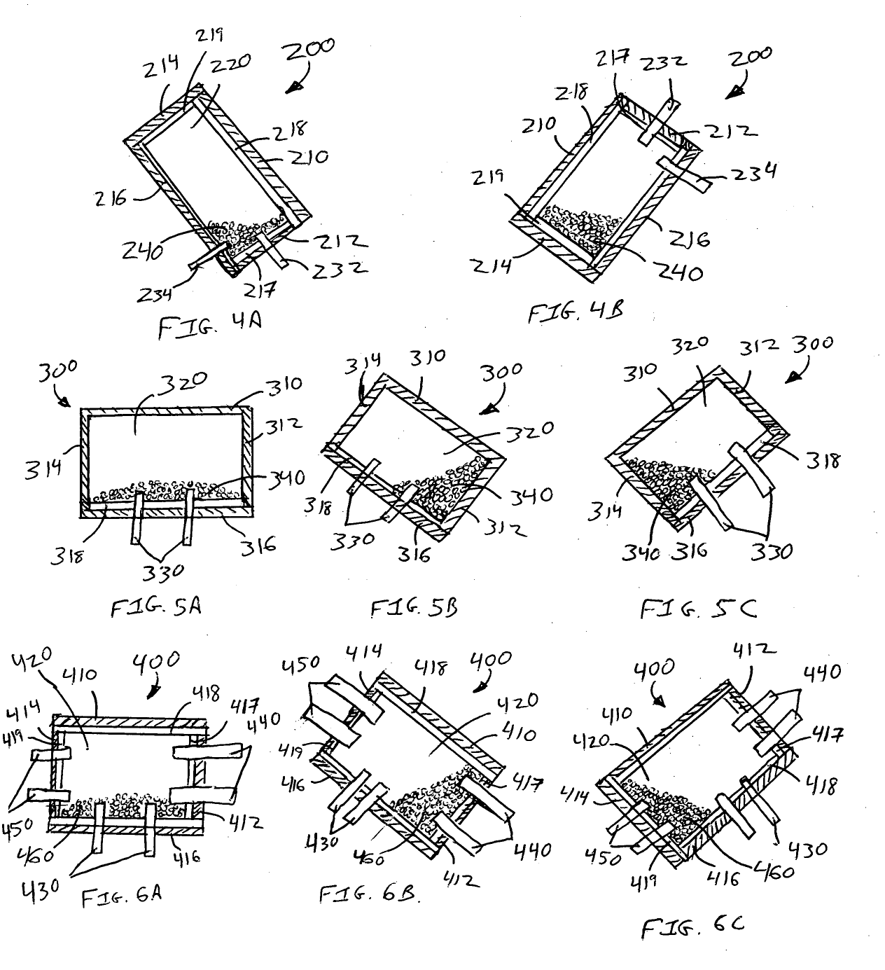

FIG. 4A shows a cross-section view of a further embodiment of the tilt responsive circuit controller utilizing conductive particles 200 in a first angled position. Controller 200 includes a casing 210, a first conductive contact 232, a second conductive contact 234, and a plurality of conductive particles 240 contained within casing 210. Casing 210 defines a vacuum-sealed interior region 220, and includes a first end 212, a second end 214, and a tubular portion 216 connected to and disposed between first end 212 and second end 214. Casing 210 includes a friction-reducing substance 218 coated on the inner surface thereof. Substance 218 can be a flouropolymer, or other substance that reduces friction between materials. Casing 210 can comprise glass, a ceramic material, a conductive material, a polymeric material, or combinations and variations thereof. First conductive contact 232 is connected first end 212. Second conductive contact 234 is connected to the region of tubular portion 216 that substantially adjacent to first end 212.

Conductive particles 240 each have a diameter substantially less than the diameter of casing 210. Conductive particles 240 are preferably spherical in shape, but can also be various other shapes that are capable of moving along a surface. Conductive particles 240 can be comprised of several conductive materials such as gold, nickel, copper, steel and tin. In the position as shown, conductive particles 240 accumulate towards first end 212 and contact both first conductive contact 232 and second conductive contact 234. If contacts 232 and 234 are connected to an electrical circuit (not shown), the circuit will be closed and electricity will flow through particles 240.

FIG. 4B shows a cross-section view of controller 200 in a second angled position. In this position, conductive particles 240 accumulate towards second end 214 and away from contacts 232 and 234. If contacts 232 and 234 are connected to an electrical circuit (not shown), the circuit connection will be open and electricity will not flow through conductive particles 240.

FIG. 5A shows a cross-section view of still another embodiment of the tilt responsive circuit controller utilizing conductive particles 300 in a first angled position. Controller 300 includes a casing 310, a set of conductive contacts 330, and a plurality of conductive particles 340 contained within casing 310. Casing 310 defines a vacuum-sealed interior region 320, and includes a first end 312, a second end 314, and a tubular portion 316 connected to and disposed between first end 312 and second end 314. Casing 310 includes a friction-reducing substance 318 coated on the inner surface thereof. Substance 318 can be a flouropolymer, or other substance that reduces friction between materials. Casing 310 can comprise glass, a ceramic material, a conductive material, a polymeric material, or combinations and variations thereof. Conductive contacts 330 are connected to tubular portion 316, preferably in the center portion. However, other locations of conductive contacts 330 along tubular portion are within the scope of this invention. For example, one of conductive contacts 330 can be located on one end of tubular portion 316, while the other conductive contact 330 can be located on the other end of tubular portion 316.

Conductive particles 340 each have a diameter substantially less than the diameter of casing 310. Conductive particles 340 are preferably spherical in shape, but can also be various other shapes that are capable of moving along a surface. Conductive particles 340 can be comprised of several conductive materials such as gold, nickel, copper, steel and tin. In the position as shown, conductive particles 340 accumulate towards the bottom surface of tubular portion 316, contacting conductive contacts 330. If contacts 330 are connected to an electrical circuit (not shown), the circuit will be closed and electricity will flow through conductive particles 340.

FIG. 5B shows a cross-section view of controller 300 in a second angled position. In this position, conductive particles 340 accumulate towards first end 312 and away from contacts 330. In this position, it is possible that conductive particles 340 may remain engaged with one of contacts 330. However, if contacts 330 are connected to an electrical circuit (not shown), because both of contacts 330 are not engaged by conductive particles 340, the circuit connection will be opened and electricity will not flow through conductive particles 340.

FIG. 5C shows a cross-section view of controller 300 in a third angled position. In this position, conductive particles 340 accumulate towards second end 314 and away from contacts 330. In this position, it is possible that conductive particles 340 may remain engaged with one of contacts 330. However, if contacts 330 are connected to an electrical circuit (not shown), because both of contacts 330 are not engaged by conductive particles 340, the circuit connection will be opened and electricity will not flow through conductive particles 340.

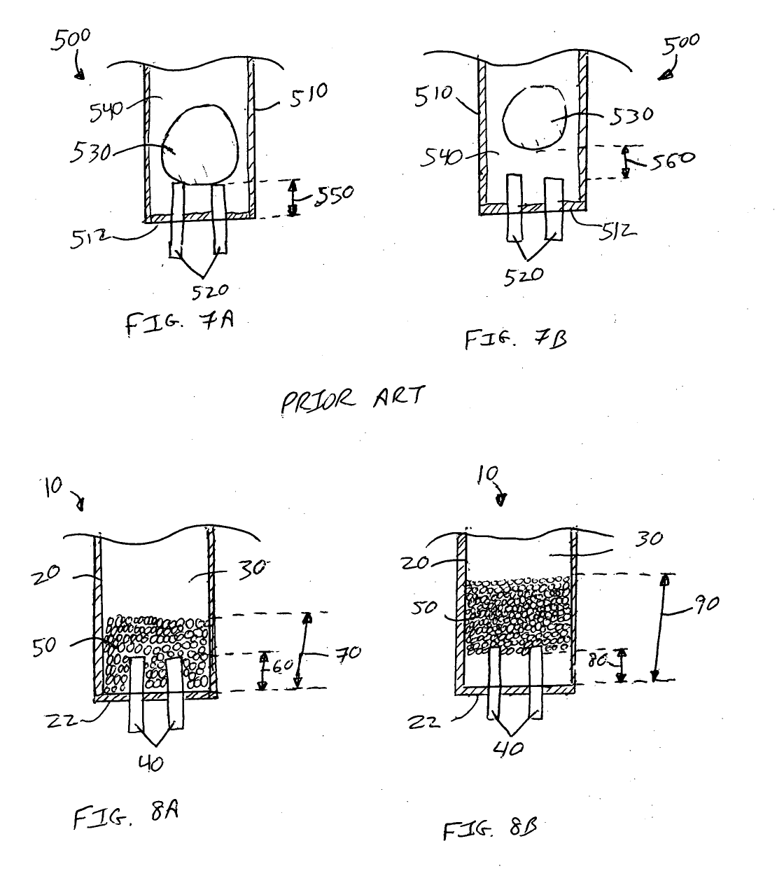

FIG. 6A shows a cross-section view of still another embodiment of the tilt responsive circuit controller utilizing conductive particles 400 in a first angled position. Controller 400 includes a casing 410, a first set of conductive contacts 430, a second set of conductive contacts 440, a third set of conductive contacts 450, and a plurality of conductive particles 460 contained within casing 410. Casing 410 defines a vacuum-sealed interior region 420, and includes a first end 412, a second end 414, and a tubular portion 416 connected to and disposed between first end 412 and second end 414. Casing 410 includes a friction-reducing substance 418 coated on the inner surface thereof. Substance 418 can be a flouropolymer, or other substance that reduces friction between materials. Casing 410 can comprise glass, a ceramic material, a conductive material, a polymeric material, or combinations and variations thereof. Conductive contacts 430 are connected to tubular portion 416, preferably in the center portion. However, other locations of conductive contacts 430 along tubular portion are within the scope of this invention. For example, one of conductive contacts 430 can be located on one end of tubular portion 416, while the other conductive contact 430 can be located on the other end of tubular portion 416. Conductive contacts 440 are coupled to first end 412. Contacts 440 are separated by a distance that can vary depending on the size of casing 410. Conductive contacts 450 are coupled to second end 414. Contacts 450 are separated by a distance that can vary depending on the size of casing 410.

Conductive particles 460 each have a diameter substantially less than the diameter of casing 410. Conductive particles 460 are preferably spherical in shape, but can also be various other shapes that are capable of moving along a surface. Conductive particles 460 can be comprised of several conductive materials such as gold, nickel, copper, steel and tin. In the position as shown, conductive particles 460 accumulate towards the bottom surface of tubular portion 416, contacting conductive contacts 430. If contacts 430 are connected to an electrical circuit (not shown), the circuit will be closed and electricity will flow through conductive particles 460.

FIG. 6B shows a cross-section view of controller 400 in a second angled position. In this position, conductive particles 460 accumulate towards first end 412 and conductive contacts 440, and away from contacts 430 and 450. If contacts 430 and/or 450 are connected to an electrical circuit (not shown), the connection will be broken for those circuits. If contacts 440 are connected to an electrical circuit (not shown), the circuit will be closed and electricity will flow through conductive particles 460.

FIG. 6C shows a cross-section view of controller 400 in a third angled position. In this position, conductive particles 460 accumulate towards second end 414 and conductive contacts 450, and away from contacts 430 and 440. If contacts 430 and/or 440 are connected to an electrical circuit (not shown), the circuit connection will be broken for those circuits. If contacts 450 are connected to an electrical circuit (not shown), the circuit will be closed and electricity will flow through particles 460.

FIG. 7A shows a cross-section view of a prior art tilt responsive circuit controller using a single metallic ball 500, wherein controller 500 is in an undisturbed state. Controller 500 includes a casing 510, a set of contacts 520, and a conductive ball 530. Casing 510 defines an interior region 540. Contacts 520 are partially disposed through one end 512 of casing 510, such that they are positioned within interior region 540 by a certain distance A, represented by reference number 550. As shown, controller 500 is in an undisturbed state, wherein no external forces or vibrations are acting upon controller 500, with ball 530 resting upon contacts 520, thereby creating a conductive path between contacts 520.

FIG. 7B shows a cross-section view of controller 500 in a disturbed state. A disturbed state occurs when controller 500 is acted upon by an external force or vibration such that ball 530 is separated from contacts 520. In this figure, end 512 is acted upon by an upward external force or vibration to cause ball 530 to be separated from contacts 520 by a distance B, represented by reference number 560. When this occurs, the conductive path between contacts 520 is broken until the external force or vibration no longer acts upon controller 500 and conductive ball 530 rests upon contacts 520. The duration of the broken connection depends on several factors including the magnitude of the external force or vibration, the weight of ball 530, and the angular position of casing 510.

FIG. 8A shows a cross-section view of controller 10 in an undisturbed state. Contacts 40 are partially disposed through end 22 of casing 20, such that they are positioned within interior region 30 by a certain distance X, represented by reference number 60. Distance X is the same as distance A as described with respect to FIG. 7A. As shown, controller 10 is in an undisturbed state, with conductive particles 50 resting upon contacts 40, thereby creating a conductive path between contacts 40. The height, Y, of particles 50 within casing 20 is represented by reference number 70. Particle height Y in controller 10 can vary so long as it is greater than distance X. In other embodiments, such as controllers 100 and 400, wherein there are conductive contacts on each end of the casing, particle height Y must be less than the length of the casing minus distance X, to prevent shorting of one set of contacts to the other. As shown, particles 50 are positioned within casing 20 to surround contacts 40 and provide a secure conductive path.

FIG. 8B shows a cross-section view of controller 10 in a disturbed state. A disturbed state occurs when controller 10 is acted upon by an external force or vibration, caused from any source including humans, machines, animals, and natural forces, such that conductive particles 50 are separated from contacts 40. In this figure, end 22 is acted upon by an upward external force or vibration to cause conductive particles 50 to be separated from contacts 40 by a distance Z, represented by reference number 80. For illustration purposes, it will be assumed that the external force or vibration caused upon controller 10 in FIG. 8B is the same external force or vibration caused upon controller 500 in FIG. 7B, such that distance Z is the same distance as distance B. The height of particles 50 in a disturbed state is represented by reference number 90, which is the sum of distance Y and distance Z. When this occurs, contrary to the prior art device, the conductive path between contacts 40 is not broken. The conductive path is not broken due to the fact that the conductive particles 50 can be positioned between contacts 40 and between contacts 40 and casing 20, thus allowing a greater contact surface area between particles 50 and contacts 40 than in the prior art devices. Therefore, as long as the external force or vibration causes a separation distance Z that is less than or equal to distance X, there will be no loss in conduction within controller 10. This represents an advance over prior art devices that cannot withstand any external forces or vibrations that separate the conductive ball from the contacts without the conductive path being broken for a certain period of time.

This document describes various embodiments of an invention relating to a tilt-responsive circuit controller utilizing conductive particles. This is done for illustration purposes only. Neither the specific embodiments of the invention as a whole, nor those of its features limit the general principles underlying the invention. The invention is not limited to automotive uses. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

I claim:

1. A tilt-responsive circuit controller comprising:
a) a casing defining a vacuum-sealed interior region, the casing having a first end, a second end, and a tubular portion connected to and disposed between the first end and the second end, the casing having a friction-reducing substance coated on the inner surface thereof;
b) a first set of conductive contacts coupled to the first end of the casing and partially disposed within the interior region; and
c) a plurality of conductive particles contained within the interior region, the plurality of conductive particles each having a diameter substantially less than the diameter of the casing
whereby when the circuit controller is placed within an electrical circuit and when the casing is disposed at a first angled position, the plurality of conductive particles accumulate towards the first end of the casing and contact the first set of conductive contacts, causing the closing of the electrical circuit, and when the casing is disposed at a second angled position the plurality of conductive particles accumulate towards the second end of the casing, causing the opening of the electrical circuit.

2. The tilt-responsive circuit controller of claim 1, wherein the friction reducing substance is a fluoropolymer.

3. The tilt-responsive circuit controller of claim 1, wherein the casing comprises at least one of an electrically non-conductive material selected from the group of materials consisting of glasses, polymers, and ceramics.

4. The tilt-responsive circuit controller of claim 1, wherein the casing is comprised of a silica-based material.

5. The tilt-responsive circuit controller of claim 1, wherein the plurality of conductive particles are comprised of material selected from the group consisting of gold, nickel, copper, steel and tin.

6. The tilt-responsive circuit controller of claim 1, wherein the plurality of particles are substantially spherical in shape.

7. The tilt-responsive circuit controller of claim 1 further comprising a second set of conductive contacts coupled to the second end of the casing and partially disposed within the interior region, the second set of conductive contacts spaced apart by a contact separation distance, whereby when the circuit controller is placed within an electrical circuit and when the casing is disposed at a second angled position the plurality of conductive particles accumulate towards the second end of the casing and contact the second set of conductive contacts, thereby closing an electrical circuit connected to the second set of conductive contacts.

8. The tilt-responsive circuit controller of claim 7 further comprising a third set of conductive contacts coupled to the tubular portion of the casing and partially disposed within the interior region, whereby wherein when the casing is disposed at a third position, the plurality of conductive particles accumulate within the tubular portion of the casing and contact the third set of conductive contacts, causing the opening of the electrical circuit at the first end and the second end and causing the closing of an electrical circuit connected to the third set of conductive contacts.

9. The tilt-responsive circuit controller of claim 1 further comprising a second set of conductive contacts coupled to the tubular portion of the casing and partially disposed within the interior region, whereby wherein when the casing is disposed at a second position, the plurality of conductive particles accumulate within the tubular portion of the casing and contact the second set of conductive contacts, causing the opening of the electrical circuit at the first end and causing the closing of an electrical circuit connected to the second set of conductive contacts.

10. The tilt-responsive circuit controller of claim 1, wherein the first end is comprised of a non-conductive material, and the second end and tubular portion are comprised of a conductive material.

11. The tilt-responsive circuit controller of claim 1, wherein the first end is removably coupled to the tubular portion.

12. The tilt-responsive circuit controller of claim 1, wherein each of the first set of conductive contacts are separated by a contact separation distance and the plurality of conductive particles each have a diameter less than the contact separation distance.

13. A tilt-responsive circuit controller comprising:
a) a casing defining a vacuum-sealed interior region, the casing having a first end, a second end, and a tubular portion connected to and disposed between the first end and the second end, the casing having a friction-reducing substance coated on the inner surface thereof;
b) a first set of conductive contacts coupled to the first end of the casing and partially disposed within the interior region;
c) a second set of contacts coupled to the second end of the casing and partially disposed within the interior region; and
d) a plurality of conductive particles contained within the interior region, the plurality of conductive particles each having a diameter substantially less than the diameter of the casing
whereby when the circuit controller is placed within an electrical circuit and when the casing is disposed at a first angled position, the plurality of conductive particles accumulate towards the first end of the casing and contact the first set of conductive contacts, causing the closing of the electrical circuit, and when the casing is disposed at a second angled position the plurality of conductive particles accumulate towards the second end of the casing and contact the second set of conductive contacts, causing the opening of the electrical circuit at the first end and the closing of an electrical circuit at the second end.

14. The tilt-responsive circuit controller of claim 13, wherein the friction reducing substance is a fluoropolymer.

15. The tilt-responsive circuit controller of claim 13, wherein the casing comprises at least one of an electrically non-conductive material selected from the group of materials consisting of glasses, polymers, and ceramics.

16. The tilt-responsive circuit controller of claim 13, wherein the casing is comprised of a silica-based material.

17. The tilt-responsive circuit controller of claim 13, wherein the plurality of conductive particles are comprised of material selected from the group consisting of gold, nickel, copper, steel and tin.

18. The tilt-responsive circuit controller of claim 13, wherein the plurality of particles are substantially spherical in shape.

19. The tilt-responsive circuit controller of claim 13, wherein each of the first set of conductive contacts are separated by a contact separation distance and the plurality of conductive particles each have a diameter less than the contact separation distance.

20. The tilt-responsive circuit controller of claim 13 further comprising a third set of conductive contacts coupled to the tubular portion of the casing and partially disposed within the interior region, whereby wherein when the casing is disposed at a third position, the plurality of conductive particles accumulate within the tubular portion of the casing and contact the third set of conductive contacts, causing the opening of the electrical circuit at the first end and the second end and causing the closing of an electrical circuit connected to the third set of conductive contacts.

21. A tilt-responsive circuit controller comprising:
a) a casing defining a vacuum-sealed interior region, the casing having a first end, a second end, and a tubular portion disposed between the first end and the second end, the casing having a friction-reducing substance coated on the inner surface thereof;
b) a first set of conductive contacts coupled to the first end of the casing and partially disposed within the interior region;
c) a second set of contacts coupled to the first end of the casing and partially disposed within the interior region;
d) a third set of conductive contacts coupled to the tubular portion of the casing and partially disposed within the interior region; and
e) a plurality of substantially spherical shaped conductive particles contained within the interior region, the plurality of conductive particles each having a diameter substantially less than the diameter of the casing
whereby when the circuit controller is placed within an electrical circuit and when the casing is disposed at a first angled position, the plurality of conductive particles accumulate towards the first end of the casing and contact the first set of conductive contacts, causing the closing of the electrical circuit, when the casing is disposed at a second angled position the plurality of conductive particles accumulate towards the second end of the casing and contact the second set of conductive contacts, causing the opening of the electrical circuit at the first end and the closing of an electrical circuit at the second end, and when the casing is disposed at a third position, the plurality of conductive particles accumulate within the tubular portion of the casing and contact the third set of conductive contacts, causing the opening of the electrical circuit at the first end and the second end and causing the closing of an electrical circuit connected to the third set of conductive contacts.

22. The tilt-responsive circuit controller of claim 21, wherein the plurality of substantially spherical shaped conductive particles are comprised of material selected from the group consisting of gold, nickel, copper, steel and tin.

23. The tilt-responsive circuit controller of claim 21, wherein the casing comprises at least one of an electrically non-conductive material selected from the group of materials consisting of glasses, polymers, and ceramics.

24. The tilt-responsive circuit controller of claim 21, wherein the casing is comprised of a silica-based material.

25. A tilt-responsive circuit controller comprising:
a) a casing defining a vacuum-sealed interior region, the casing having a first end, a second end, and a tubular portion disposed between the first end and the second end, the casing having a friction-reducing substance coated on the inner surface thereof;
b) a first conductive contact coupled to the first end and partially disposed within the interior region;
c) a second conductive contact coupled to the region of the tubular portion substantially adjacent to the first end and partially disposed within the interior region; and
d) a plurality of conductive particles contained within the interior region, the plurality of conductive particles each having a diameter substantially less than the diameter of the casing
whereby when the circuit controller is placed within an electrical circuit and when the casing is disposed at a first angled position, the plurality of conductive particles accumulate towards the first end of the casing and contact both the first conductive contact and the second conductive contact, causing the closing of the electrical circuit, and when the casing is disposed at a second angled position the plurality of conductive particles accumulate towards the second end of the casing, causing the opening of the electrical circuit.

26. A tilt-responsive circuit controller comprising:
a) a casing defining a vacuum-sealed interior region, the casing having a first end, a second end, and a tubular portion disposed between the first end and the second end, the casing having a friction-reducing substance coated on the inner surface thereof;
b) a first set of conductive contacts coupled to the region of the tubular portion substantially adjacent to the first end and partially disposed within the interior region; and
c) a plurality of conductive particles contained within the interior region, the plurality of conductive particles each having a diameter substantially less than the diameter of the casing
whereby when the circuit controller is placed within an electrical circuit and when the casing is disposed at a first angled position, the plurality of conductive particles accumulate towards the first end of the casing and contact the first set of conductive contacts, causing the closing of the electrical circuit, and when the casing is disposed at a second angled position the plurality of conductive particles accumulate towards the second end of the casing, causing the opening of the electrical circuit.

27. A tilt-responsive circuit controller comprising:
a) a casing defining a vacuum-sealed interior region, the casing having a first end, a second end, and a tubular portion connected to and disposed between the first end and the second end, the casing having a friction-reducing substance coated on the inner surface thereof;
b) a first set of conductive contacts coupled to the first end of the casing and partially disposed within the interior region, the first set of conductive contacts separated by a contact separation distance; and
c) a plurality of substantially spherical conductive particles contained within the interior region, the plurality of conductive particles each having a diameter substantially less than the contact separation distance
whereby when the circuit controller is placed within an electrical circuit and when the casing is disposed at a first angled position, the plurality of conductive particles accumulate towards the first end of the casing and contact the first set of conductive contacts, causing the closing of the electrical circuit, and when the casing is disposed at a second angled position the plurality of conductive particles accumulate towards the second end of the casing, causing the opening of the electrical circuit.
